(19) United States
(12) Patent Application Publication
(10) Pub. No.: US 2021/0200233 A1
(43) Pub. Date: Jul. 1, 2021

(54) MOTION CONTROL METHOD, APPARATUS AND SYSTEM

(71) Applicant: SHENZHEN SENSETIME TECHNOLOGY CO., LTD., Shenzhen (CN)

(72) Inventors: Junwei ZHANG, Shenzhen (CN); Chenyu HUANG, Shenzhen (CN); Nanxian LI, Shenzhen (CN); Haosong LIU, Shenzhen (CN)

(21) Appl. No.: 17/203,128

(22) Filed: Mar. 16, 2021

Related U.S. Application Data
(63) Continuation of application No. PCT/CN2020/087003, filed on Apr. 26, 2020.

(30) Foreign Application Priority Data
Apr. 30, 2019 (CN) 201910362940.8

(51) Int. Cl. G05D 1/02; G01J 3/50

(52) U.S. Cl. CPC G05D 1/0242; G01J 3/50; G05D 1/0246

(57) ABSTRACT

Disclosed are a motion control method, apparatus and system. The method includes: acquiring a detection signal, wherein the detection signal is generated by an electronic device through sensing a color state of a present motion track of the electronic device; and controlling motion of the electronic device according to the detection signal.

### CROSS-REFERENCE TO RELATED APPLICATION

This application is a continuation of International Application No. PCT/CN2020/087003, filed on Apr. 26, 2020, which claims priority to Chinese Patent Application No. 201910362940.8, filed to the China National Intellectual Property Administration on Apr. 30, 2019 and entitled “Motion Control Method, Apparatus and System”. The disclosures of International Application No. PCT/CN2020/087003 and Chinese Patent Application No. 201910362940.8 are hereby incorporated by reference in their entireties.

### TECHNICAL FIELD

The present disclosure relates to the technical field of embedded systems, and in particular, to a motion control method, apparatus and system.

### BACKGROUND

An automatically movable electronic device is a common form of object used in development of embedded systems, has been used in the field of education, engineering measurement and even military and police instruments for a long time. At present, the automatically movable electronic device usually recognizes a motion track through infrared sensors so as to realize automatic motion.

### SUMMARY

A technical solution for motion control is provided in the disclosure.

According to an aspect of the present disclosure, a motion control method is provided, including: acquiring a detection signal, wherein the detection signal is generated by an electronic device through sensing a color state of a present motion track of the electronic device; and controlling motion of the electronic device according to the detection signal.

According to an aspect of the present disclosure, provided is a motion control apparatus, including: a detection signal acquisition module, configured to acquire a detection signal, wherein the detection signal is generated by an electronic device through sensing a color state of a present motion track of the electronic device; and a control module, configured to control motion of the electronic device according to the detection signal.

According to an aspect of the present disclosure, a motion control apparatus is provided. The motion control apparatus may include: a processor; and a memory configured to store instructions executable by the processor. The processor may be configured to perform a motion control method. The motion control method includes: acquiring a detection signal, wherein the detection signal is generated by an electronic device through sensing a color state of a present motion track of the electronic device; and controlling motion of the electronic device according to the detection signal.

According to an aspect of the present disclosure, provided is a motion control system, including: the electronic device above; and an area map, configured to delimit a motion area of the motion control apparatus, wherein the area map includes motion paths of at least two different color states

According to an aspect of the present disclosure, provided is a non-transitory computer-readable storage medium having stored thereon computer program instructions. The computer program instructions, when executed by a processor, implement a motion control method including: acquiring a detection signal, wherein the detection signal is generated by an electronic device through sensing a color state of a present motion track of the electronic device; and controlling motion of the electronic device according to the detection signal.

In embodiments of the present disclosure, also provided is a computer program that, when executed by a processor, implements any motion control method described above.

It is to be understood that the above general description and detailed description below are only exemplary and explanatory and are not intended non limit the present disclosure.

According to the following detailed description of the exemplary embodiments with reference to the accompanying drawings, other characteristics and aspects of the present disclosure will become apparent.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 illustrates a flowchart of a motion control method according to an embodiment of the present disclosure.

FIG. 2 illustrates a flowchart of a motion control method according to an embodiment of the present disclosure.

FIG. 3 illustrates a flowchart of a motion control method according to an embodiment of the present disclosure.

FIG. 4 illustrates a flowchart of a motion control method according to an embodiment of the present disclosure.

FIG. 5 illustrates a flowchart of a motion control method according to an embodiment of the present disclosure.

FIG. 6 illustrates a flowchart of a motion control method according to an embodiment of the present disclosure.

FIG. 7 illustrates a block diagram of a motion control apparatus according to an embodiment of the present disclosure.

FIG. 8 illustrates a block diagram of a motion control system according to an embodiment of the present disclosure.

FIG. 9 illustrates a schematic diagram of an application example according to the present disclosure.

FIG. 10 illustrates a block diagram of an electronic device according to embodiments of the present disclosure.

FIG. 11 illustrates a block diagram of an electronic device according to embodiments of the present disclosure.

### DETAILED DESCRIPTION

Various exemplary embodiments, features and aspects of the present disclosure will be described below in detail with reference to the accompanying drawings. A same numeral in the accompanying drawings indicates a same or similar component. Although various aspects of the embodiments are illustrated in the accompanying drawings, the accompanying drawings are unnecessarily drawn to scale unless otherwise specified.

As used herein, the word “exemplary” means “serving as an example, embodiment, or illustration”. Thus, any embodiment described herein as “exemplary” is not necessarily to be construed as preferred or advantageous over other embodiments.

The term “and/or” in this specification only describes an association relationship of associated objects and represents that three relationships may exist. For example, A and/or B may represent the following three cases: only A exists, both A and B exist, and only B exists. In addition, the term “at least one” herein represents any one of multiple, or any combination of at least two in the multiple, for example, at least one of A, B and C may represent any one or multiple elements selected from a set formed by A, B and C.

In addition, for describing the disclosure better, many specific details are presented in the following detailed description. It is to be understood by those skilled in the art that the present disclosure may still be implemented even without some specific details. In some examples, methods, means, components and circuits known very well to those skilled in the art are not described in detail, to highlight the subject of the present disclosure.

It is to be understood that the method embodiments mentioned in the present disclosure may be combined with each other to form a combined embodiment without departing from the principle and logic, which will not be elaborated in the embodiments of the present disclosure for simplicity.

In addition, the present disclosure also provides an image processing apparatus, an electronic device, a computer-readable storage medium and a program, which may be used for implementing any image processing method provided by the present disclosure. The corresponding technical solution and description and the corresponding description may refer to the description of method part, which will not be described in detail.

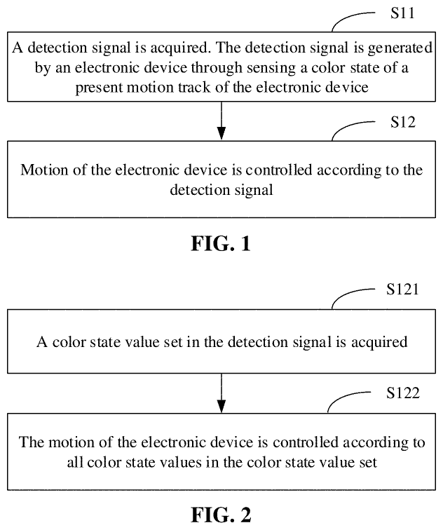

FIG. 1 illustrates a flowchart of a motion control method according to an embodiment of the present disclosure. As illustrated in the figure, the motion control method may include the following actions.

In S11, a detection signal is acquired. The detection signal is generated by an electronic device through sensing a color state of a present motion track of the electronic device.

In S12, motion of the electronic device is controlled according to the detection signal.

The electronic device in the embodiments of the present disclosure may be any hardware device having a motion function, is not specifically limited herein, and may be flexibly selected according to actual conditions. In a possible implementation, the electronic device may be a patrol trolley. In a possible implementation, the electronic device may be a robot with a motion function. In a possible implementation, the electronic device may be a motion device for embedded development. The motion control method according to the embodiment of the present disclosure may be executed by hardware or executed by a processor running computer-executable code.

Through the motion control method according to the embodiment of the present disclosure, a detection signal is generated by sensing a color state of a present motion track, and then the motion of an electronic device is controlled based on the detection signal. Through the above process, a motion direction of the electronic device can be controlled by sensing a color state of a motion track of the electronic device, so that the mode of controlling the motion of the electronic device is effectively extended. Moreover, the control is realized based on sensing the color state of the motion track, so that a smaller number of sensing identification devices are needed. The cost is reduced, and the extensibility is improved. The solution is suitable for all-around popularization. Moreover, since a smaller number of sensing identification devices are needed, the number of sensing identification devices can be effectively reduced for the electronic device to which the motion control method is applied. In turn, the volume of the entire electronic device is significantly reduced, and the motion flexibility of the electronic device is improved.

The detection signal is generated by sensing the color state of the present motion track in S11, and the specific implementation of the sensed color state is not limited. Namely, the content of the sensed color state is not limited. In a possible implementation, the color state includes a color chroma state and/or a color brightness state.

In one example, the color state may be the color chroma of the present motion track, i.e., the color of the present motion track, and the specific color may be determined according to actual conditions and is not limited here. In one example, the color may be red, green, or black, or may be a color determined by mixing red, green, or black in different proportions.

In one example, the color state may be the color brightness of the present motion track, i.e., the brightness of the present motion track, and the specific brightness may be determined according to actual conditions and is not limited here. In one example, the color brightness of the motion track may be changed by changing the illumination intensity of light of a certain fixed color.

In one example, the color state may be both the color chroma and the color brightness of the present motion track. In one example, the color chroma and brightness of the motion track may be changed simultaneously by changing the illumination intensity of light of different colors.

By setting different forms of color states, corresponding detection signals can be flexibly generated, so that the motion of the electronic device is controlled according to the detection signals. As such, the mode of controlling motion of the electronic device can be extended to a greater extent, and the extensibility of the motion control method can be promoted.

In S11, the detection signal is generated by the electronic device through sensing the color state of the present motion track. In the embodiment of the present disclosure, the implementation form of S11 is not limited, i.e. the specific implementation of acquiring the detection signal that is generated through sensing the color state of the present motion track is not limited in the embodiment of the present disclosure.

In a possible implementation, S11 may be implemented by a color sensor. In one example, in S11, the detection signal may be generated by the color sensor through reading the color of the present motion track. The specific implementation of the color sensor is also not limited, and any device capable of sensing the color of a target object to generate a color-related sensing signal may be implemented as the color sensor. Therefore, in one example, the specific type or model of color sensor may be flexibly selected according to actual conditions.

In one example, S11 may be implemented by a brightness sensor. In one example, in S11, the detection signal may be generated by the brightness sensor through reading the brightness of the present motion track. The specific implementation of the brightness sensor is also not limited, and any device capable of sensing the brightness of a target object to generate a brightness-related sensing signal may be implemented as the brightness sensor. Therefore, in one example, the specific type or model of brightness sensor may be flexibly selected according to actual conditions.

In addition, in S11, the frequency of acquiring the detection signal is also not limited, i.e. the specific time interval at which the electronic device acquires the detection signal that is generated by the electronic device through sensing the color state of the present motion track is not limited. The time interval is not limited, and can be flexibly set according to actual conditions and is not limited numerically.

The detection signal generated by the electronic device through sensing the color state of the present motion track is acquired, and the detection signal can be further used as the basis for controlling the motion of the electronic device in the subsequent action S12. The detection signal acquired in this way is mainly generated according to a sensing signal generated by sensing the color state. Compared with detection signals generated through infrared sensing or in other sensing modes, the acquisition mode is more convenient, and requires a smaller number of sensing devices during implementation. Thus, the volume and the construction cost of the entire electronic device are effectively reduced. Moreover, the motion direction of the electronic device can be controlled by changing the color in a motion area of the electronic device. The control mode is more flexible and diversified, is not limited by the number of sensing devices, and is suitable for universal popularization.

The implementation of S12 is also not limited. Any process in which the motion of the electronic device can be controlled according to the detection signal can be implemented as S12. As can be seen from the various embodiments of the disclosure, the implementation of S11 is not limited. Therefore the specific signal form of the acquired detection signal is also not limited, and the control process may also be implemented in various forms for different forms of detection signals.

FIG. 2 illustrates a flowchart of a motion control method according to an embodiment of the present disclosure. As illustrated in the figure, in a possible implementation, S12 may include the following actions.

In S121, a color state value set in the detection signal is acquired.

In S122, the motion of the electronic device is controlled according to all color state values in the color state value set.

Through the implementation in the above embodiments of the disclosure, the motion of the electronic device can be controlled according to all the color state values in the color state value set in the detection signal, and the control mode can be realized by a reading a numerical value or comparison of numerical values. When the control mode is realized by comparison of numerical values, higher-precision control can be realized by a simpler judgment process. The motion precision is ensured while the difficulty in realizing the method is reduced, and the scheme is suitable for wide application. When the control mode is realized by reading a numerical value, the motion control process can be enabled to have higher precision, so that the final motion precision is improved.

As can be seen from the various embodiments of the disclosure, in a possible implementation, the detection signal generated by sensing the color state of the present motion track may include a color state value set. In this case, the motion of the electronic device can be controlled correspondingly based on data in the color state value set. The type and quantity of data contained in the color state value set are also not limited and can be flexibly determined according to actual conditions. Therefore, the control mode changes as the type and quantity of the data contained in the color state value set are different. Therefore the implementation of S122 is also not limited and can be flexibly determined according to actual conditions.

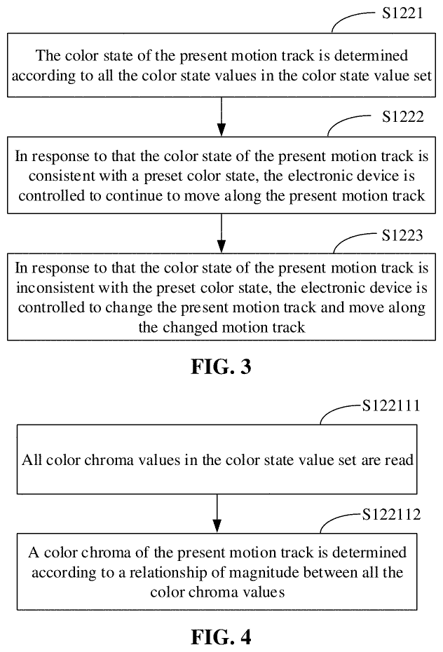

FIG. 3 illustrates a flowchart of a motion control method according to an embodiment of the present disclosure. As illustrated in the figure, in a possible implementation, S122 may include the following actions.

In S1221, the color state of the present motion track is determined according to all the color state values in the color state value set.

In S1222, in response to that the color state of the present motion track is consistent with a preset color state, the electronic device is controlled to continue to move along the present motion track.

In S1223, in response to that the color state of the present motion track is inconsistent with the preset color state, the electronic device is controlled to change the present motion track and move along the changed motion track.

As can be seen from the various embodiments of the disclosure, in a possible implementation, in S122, the color state of the present motion track may be determined through all the color state values in the color state value set; then when the color state of the motion track is consistent with a preset color state, the electronic device is controlled to continue to move along the present motion track; and when the color state of the motion track is inconsistent with the preset color state, the electronic device is controlled to change the present motion track and move along the changed motion track. In this way, the electronic device can be effectively controlled to move on a track line with a preset color state. Once the electronic device deviates from the track line with the preset color state, the detected color state is inconsistent with the preset color state; at this time, the electronic device can be controlled to change the motion track so that the electronic device can finally return to the preset track line. In this way, a motion process with automatic deviation rectification can be realized. The motion mode is simple to control, easy to realize and suitable for universal popularization.

In addition, there may be other implementations of S122, and in a possible implementation, S122 may include the following actions.

The color state of the present motion track is determined according to all the color state values in the color value set.

In response to that the color state of the present motion track is inconsistent with a preset color state, the electronic device is controlled to continue to move along the present motion track.

In response to that the color state of the present motion track is consistent with the preset color state, the electronic device is controlled to change the present motion track and move along the changed motion track.

Through the control method, the electronic device can be effectively controlled to move on a track line with a preset color state. Once deviating from the track line with the preset color state, the detected color state is inconsistent with the preset color state, and at this moment, the electronic device can be controlled to change the motion track, so that the electronic device can finally return to the preset track line to realize an automatic deviation rectifying motion process. The motion mode is simple to control, easy to realize and suitable for universal popularization.

As can be seen from the disclosed embodiments, the approach of controlling the motion of the electronic device may be flexibly adjusted. The electronic device may be controlled to continue to move along the present motion track when the color state is the same as the preset color state, and the electronic device may also be controlled to continue to move along the present motion track when the color state is different from the preset color state. There may be other standards of control based on the color state, without being limited to the above two control modes. Therefore, the motion control method provided by the embodiment of the present disclosure has higher flexibility in the control mode, can be flexibly extended and determined according to actual conditions, and is thus suitable for wide-range use and popularization.

The specific implementation of S1221 in S122 is also not limited besides that the control mode is not limited. It has been proposed in the above disclosed embodiment that the type and quantity of data contained in the color state value set are also not limited and can be flexibly determined according to actual conditions. Therefore, the mode of determining the color state of the present motion track according to all the color state values in the color state value set accordingly changes, as the type and quantity of data contained in the color state value set are different. In a possible implementation, the sensed color state may be color chroma. In this case, the content contained in the color state value set may be color chroma values. The color chroma of the present motion track may be determined based on the color chroma values in the color state value set.

The specific implementation of determining the color chroma of the present motion track according to the color chroma values in the color state value set is also not limited.

FIG. 4 illustrates a flowchart of a motion control method according to an embodiment of the present disclosure. As illustrated in the figure, in a possible implementation, S1221 may include the following actions.

In S122111, all color chroma values in the color state value set are read.

In S122112, a color chroma of the present motion track is determined according to a relationship of magnitude between all the color chroma values.

The color chroma of the present motion track is determined through the relationship of magnitude between the color chroma values, and the determined color chroma is taken as the color state of the motion track. This approach of determining the color chroma is quick and convenient and is efficient, so that the efficiency of the entire control process can be improved.

As can be seen from the above embodiments of the disclosure, in a possible implementation, the color chroma of the present motion track may be determined according to the relationship of magnitude between all the color chroma values. In addition, the color chroma of the present motion track may be directly determined according to the numerical value reading by directly reading the numerical values of all the color chroma values. The method for determining the color chroma of the present motion track may be flexibly determined according to actual conditions, and is not limited to the two implementations.

In a possible implementation, the color chroma values of the motion track may be RGB color chroma values. In this case, in a possible implementation, S12212 may include the following actions.

It is determined that the color chroma of the present motion track is red in response to that a red (R) channel value is larger than both a green (G) channel value and a black (B) channel value among all the color chroma values.

It is determined that the color chroma of the present motion track is green in response to that the G channel value is larger than both the R channel value and the B channel value among all the color chroma values.

It is determined that the color chroma of the present motion track is black in response to that the B channel value is larger than both the R channel value and the G channel value among all the color chroma values.

As can be seen from the above embodiments of the disclosure, in a possible implementation, the data contained in the color state value set may be read RGB color chroma values of the motion track. In this case, if the motion area where the electronic device is located only contains three colors of red, black and blue, the channel values of the three colors are greatly different from one another. The color chroma of the present motion track can be determined without the need for overly complex comparison process, and it is only needed to determine which channel value among the R channel value, the G channel value and the B channel value is the largest. The color chroma of the present motion track may be determined by the simple comparison mode of the above embodiments of the disclosure. If the colors in the motion area where the electronic device is located are more complex, for example containing gradually changing colors or two or more colors which are more similar, the comparison mode and labels may be appropriately adjusted to determine the color chroma of the present motion track in this case. The particular way of adjustment can be flexibly determined according to the actual color chroma conditions in the motion area where the electronic device is located, and is not limited here.

The color chroma of the present motion track can be determined based on the relationship of magnitude among the R channel value, the G channel value and the B channel value. Such an approach is more convenient and quicker, and is more accurate, and the efficiency of control can be improved while the control precision is guaranteed

In addition, it has been proposed in the above embodiments of the disclosure that, in a possible implementation, the sensed color state may be color brightness. Therefore, the content contained in the color state value set may be a color brightness value in this case. In this case, the color brightness of the present motion track may be determined based on the color brightness value in the color brightness value set.

The specific implementation of determining the color brightness of the present motion track according to the color brightness value in the color state value set is also not limited.

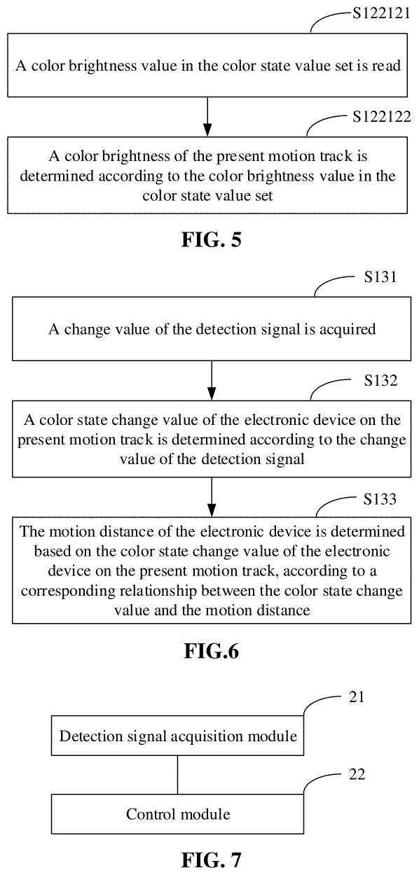

FIG. 5 illustrates a flowchart of a motion control method according to an embodiment of the present disclosure. As illustrated in the figure, in a possible implementation, S1221 may include the following actions.

In S122121, a color brightness value in the color state value set is read.

In S122122, a color brightness of the present motion track is determined according to the color brightness value in the color state value set.

The color brightness is taken as the color state of the motion track, so that the efficiency of determining the color state of the motion track can be further improved, thereby improving the control efficiency.

As can be seen from the above embodiments of the disclosure, in a possible implementation, the color brightness of the present motion track may be determined according to the color brightness value in the color state value set. The particular manner of determining the color brightness of the present motion track through the color brightness value may be adjusted correspondingly according to the form of the acquired color brightness value, and will not be limited herein. In one example, the color brightness value may be acquired by a brightness sensor. In this case, the color brightness of the present motion track may be determined directly by reading the color brightness value, i.e., the numerical value of the brightness sensor.

It has been proposed in the above embodiments of the disclosure that the way of controlling the motion of the electronic device is not limited. Therefore, in S1223, the mode of controlling the electronic device to change the present motion track when the color state of the present motion track is inconsistent with the preset color state is also not limited, and may be flexibly selected according to actual conditions. In a possible implementation, the operation that the electronic device is controlled to change the present motion track may include that: the electronic device is controlled to deflect for a preset angle on the basis of the present motion track.

The magnitude of the angle by which the electronic device is controlled to deflect on the basis of the present motion track may be flexibly selected according to the actual situation and is not limited to the disclosed embodiments described below.

The motion track of the electronic device is changed by controlling the electronic device to deflect for a preset angle on the basis of the present motion track, so that the motion track of the electronic device can be changed conveniently, thereby improving the convenience of motion control.

In a possible implementation, the operation that the electronic device is controlled to deflect for a preset angle on the basis of the present motion track may include that: the electronic device is controlled to deflect for a fixed angle value on the basis of the present motion track. The value of the fixed angle of deflection may be flexibly determined according to one or more of: the present motion situation of the electronic device, the actual situation of the motion area where the electronic device is located, or preset conditions, and is not particularly limited.

In one example, the fixed angle of deflection may be determined according to the color chroma of the present motion track determined through the detection signal. In one example, it may be set that the electronic device should move on a black motion track, and that red and green areas are in two opposite directions of the motion track. The electronic device may be moving to the two opposite directions when deviating from the motion track. Thus, it may be preset that the electronic device deflects toward an area having less red color when the present motion track is red, and deflects toward an area having less green color when the present motion track is green. The specific directions and positions of the red and green areas are not limited here.

In one example, it may be preset that the red area is on the left side of a travel track that the electronic device should move on, and the green area is on the right side of the travel track that the electronic device should move on. In this case, when the present motion track is red, the electronic device is controlled to deflect to the right by a degree of A; and when the present motion track is green, the electronic device is controlled to deflect to the left by a degree of B. The specific numeric values of A and B are also not limited and may be flexibly set. Furthermore, the specific numeric values of A and B may be the same as or different from each other. In one example, A and B may both be 35 degrees.

In one example, it may also be preset that the red area is on the right side of the travel track that the electronic device should move on, and the green area is also on the right side of the travel track that the electronic device should move on. In this case, when the present motion track is red, the electronic device is controlled to deflect to the left by a degree of A; and when the present motion track is green, the electronic device is controlled to deflect to the left by a degree of B. The specific numeric values of A and B are also not limited and may be flexibly set. Furthermore, the specific numeric values of A and B may be the same as or different from each other.

In one example, it may be preset that the red area is on the right side of the travel track that the electronic device should move on, and the green area is on the left side of the travel track that the electronic device should move on. In this case, when the present motion track is red, the electronic device is controlled to deflect to the left by a degree of A; and when the present motion track is green, the electronic device is controlled to deflect to the right by a degree of B degrees. The specific numeric values of A and B are also not limited and may be flexibly set. Furthermore, the specific numeric values of A and B may be the same as or different from each other.

In one example, it may be preset that the red area is on the left side of the travel track that the electronic device should move on, and the green area is also be on the left side of the travel track that the electronic device should move on. In this case, when the present motion track is red, the electronic device is controlled to deflect to the right by a degree of A; and when the present motion track is green, the electronic device is controlled to deflect to the right by a degree of B. The specific numeric values of A and B are also not limited and may be flexibly set. Furthermore, the specific numeric values of A and B may be the same as or different from each other.

In summary, both the direction of deflection and the angle of deflection corresponding to a certain detected color may be flexibly set and are not limited to the above embodiments of the disclosure.

In one example, the fixed angle of deflection may be determined according to the color brightness of the present motion track determined through the detection signal. In one example, it may be set that the electronic device should move on a motion track having color brightness C, and areas of brightness D and brightness E are in two opposite directions of the motion track with the color brightness C. The electronic device may be moving two the two opposite directions when deviating from the motion track. A magnitude relationship between brightness C, brightness D and brightness E is limited in no way, and may be flexibly determined according to actual conditions. Therefore, it may be preset that when the present motion track has a brightness D, the electronic device deflects in the direction away from the area with the brightness D; and when the present motion track has a brightness E, the electronic device deflects in the direction away from the area with the brightness E. The specific direction and position of the area with the brightness D and the area with the brightness E are not limited herein. In one example, there may be a correlation between the brightness area and the brightness. That is, the brightness may be controlled to increase or decrease sequentially according to the direction of the brightness area. In one example, the brightness area and the brightness may be not correlated. That is, a brightness and the position of the area with the brightness are not related with each other, and may be directly set as required. The specific manner of controlling the electronic device to deflect for a fixed angle as the brightness varies may be similar to the process in which the electronic device is controlled to deflect for a fixed angle as the chroma varies, and will not be described further herein. Both the direction of deflection and the angle of deflection corresponding to a certain brightness detected may be flexibly set particularly, and will not be specifically limited herein.

By controlling the electronic device to deflect for the fixed angle value on the basis of the present motion track, the efficiency in controlling motion the electronic device can be improved, and the solution is easy to realize.

In a possible implementation, the operation that the electronic device is controlled to deflect for a preset angle on the basis of the present motion track may include that: the electronic device is controlled to deflect for a dynamic angle value on the basis of the present motion track. The dynamic angle value of deflection may be comprehensively calculated according to conditions such as a control mode of the electronic device, steering conditions of the electronic device and the like, and the specific calculation conditions are not limited to the two conditions and may be flexibly determined according to actual situations. In one example, the value of the dynamic angle of deflection may be determined by a motor PID forward value of the electronic device, a steering engine PID deflection value of the electronic device and a differential steering parameter of the electronic device jointly. The calculation formula for calculating the final value of the dynamic angle of deflection through the above three values is not limited here and may be set according to actual situations. The motor PID forward value of the electronic device is an output value of a motor obtained by performing PID control on the motor. The motor may be used for controlling the electronic device to perform forward motion. The mode of calculating the motor PID forward value is also not limited and may be determined according to actual situations. In an example, the motor PID forward value may be calculated as follows:

Output1+=P1*(error1−last_error1)+I1*error1+D1*(error1+last_last_error1)

Output1 is a motor PID forward value. P1 is a proportional unit parameter in motor PID control. I1 is an integral unit parameter in motor PID control. D1 is a differential unit parameter in motor PID control. error1 is a present control error value of motor PID control. last_error1 is the last control error value of motor PID control. last_last_error1 is a control error value of motor PID control before the last control error value.

Similarly, a steering engine PID deflection value of the electronic device is an output value of a steering engine obtained by performing PID control on the steering engine. The steering engine may be used for controlling the electronic device to perform steering or other motions. The mode of calculating the steering engine PID deflection value is not limited and may be determined according to actual situations. In one example, the mode of calculating the steering engine PID deflection value may be:

Output2=P2*error2+D2*(error2−last_error2)

Output2 is a steering engine PID deflection value. P2 is a proportional unit parameter in steering engine PID control. D2 is a differential unit parameter in steering engine PID control. error2 is a present control error value of steering engine PID control. last_error2 is a last control error value of steering engine PID control.

The differential steering parameter may be obtained by reading a parameter value inside the electronic device, and the specific reading mode and setting mode of the differential steering parameter are not limited.

As can be seen from the various embodiments of the disclosure, by dynamically calculating the motor PID forward value and the steering engine PID deflection value of the electronic device, and in combination with differential steering parameter, the deflection angle of the electronic device may be comprehensively obtained. The deflection angle may change along as the motion state of the electronic device varies. Therefore, the electronic device may deflect for a dynamic angle value on the basis of the present motion track. By controlling the electronic device to deflect for the dynamic angle value on the basis of the present motion track, the precision in controlling the motion of the electronic device can be improved, thereby improving the precision of the motion of the electronic device.

In a possible implementation, the motion control method in the various embodiments of the disclosure above may further include S13: a motion distance of the electronic device is determined according to the detection signal.

By determining a motion distance of the electronic device, the electronic device can be further controlled based on the motion distance, so that the diversity of control modes is improved.

By determining the motion distance of the electronic device according to the detection signal, the motion conditions of the electronic device can be grasped better; and then the motion of the electronic device can be more accurately and flexibly controlled based on the determined motion distance.

The implementation of S13 is also not limited. FIG. 6 illustrates a flowchart of a motion control method according to an embodiment of the present disclosure. As illustrated in the figure, in a possible implementation, S13 may include the following actions.

In S131, a change value of the detection signal is acquired.

In S132, a color state change value of the electronic device on the present motion track is determined according to the change value of the detection signal.

In S133, the motion distance of the electronic device is determined based on the color state change value of the electronic device on the present motion track, according to a corresponding relationship between the color state change value and the motion distance.

As can be seen from the above various embodiments of the disclosure, the manner of acquiring the detection signal is not limited. Therefore, the manner of acquiring the change value of the detection signal also changes as the manner of acquiring the detection signal varies. Therefore, the implementation of S131 is also not limited and will not be described in detail herein.

After the change value of the detection signal is acquired, the color state change value of the detection signal on the present motion track may be determined according to the change value of the detection signal. It can also be seen from the various embodiments of the disclosure that the specific type and form of data contained in the detection signal are not limited. Therefore, how to determine the color state change value of the electronic device on the present motion track according to the change value of the detection signal is also not limited. In one example, the color state change value of the detection signal on the present motion track may be determined by calculating the change value for each of the color state values contained in the color state value set in the detection signal.

After obtaining the color state change value, the color state change value may be substituted into the corresponding relationship between the color state change value and the motion distance through S133, to obtain the motion distance of the electronic device. The manner of determining the corresponding relationship between the color state change value and the motion distance is not limited. In a possible implementation, the color state change value in the motion process may be read by controlling the electronic device to move by a fixed distance in a specified motion area, and the corresponding relationship between the color state change value and the motion distance in the motion area may be obtained through multiple experiments and summarization. In a possible implementation, the corresponding relationship between the color state change value and the motion distance may also be directly artificially set, so that the electronic device can directly read the corresponding relationship between the color state change value and the motion distance. Furthermore, the corresponding relationship between the color state change value and the motion distance is not limited in form, and the relationship between the color state change value and the motion distance may be linear or non-linear and may be flexibly determined according to actual conditions.

A change value of the detection signal is acquired, a color state change value is obtained according to the change value of the detection signal, and finally the motion distance of the electronic device is determined based on the color state change value. In this way, the motion distance may be determined directly according to the color state change sensed by the electronic device in the motion area. Such a manner of calculating the motion distance is simple and convenient. The speed of determining the motion distance of the electronic device can be greatly improved, and the convenience in controlling the movement of the electronic device is improved, and the convenience in controlling the movement of the electronic device is improved.

FIG. 7 illustrates a block diagram of a motion control apparatus according to an embodiment of the present disclosure. As illustrated in the figure, the motion control apparatus includes: a detection signal acquisition module 21 and a control module 22. The detection signal acquisition module is configured to acquire a detection signal. The detection signal is generated by an electronic device through sensing a color state of a present motion track of the electronic device. The control module 22 is configured to control motion of the electronic device according to the detection signal.

In a possible implementation, the color state may include at least one of: a color chroma state, or a color brightness state.

In a possible implementation, the control module includes: a color state value acquisition sub-module, configured to acquire a color state value set in the detection signal; and a control sub-module, configured to control the motion of the electronic device according to all color state values in the color state value set.

In a possible implementation, the control sub-module includes: a color state determination unit; and at least one of a motion track maintaining unit or a motion track change unit. The color state determination unit is configured to determine the color state of the present motion track according to all the color state values in the color state value set. The motion track maintaining unit is configured to control the electronic device to continue to move along the present motion track in response to that the color state of the present motion track is consistent with a preset color state. The motion track change unit is configured to control the electronic device to change the present motion track and move along the changed motion track in response to that the color state of the present motion track is inconsistent with the preset color state.

In a possible implementation, the color state determination unit is configured to: read all color chroma values in the color state value set; and determine a color chroma of the present motion track according to a relationship of magnitude between all the color chroma values.

In a possible implementation, the color state determination unit is further configured to: determine that the color chroma of the present motion track is red in response to that a red (R) channel value is larger than both a green (G) channel value and a black (B) channel value among all the color chroma values; determine that the color chroma of the present motion track is green in response to that the G channel value is larger than both the R channel value and the B channel value among all the color chroma values; or determine that the color chroma of the present motion track is black in response to that the B channel value is larger than both the R channel value and the G channel value among all the color chroma values.

In a possible implementation, the color state determination unit is configured to: read a color brightness value in the color state value set; and determine a color brightness of the present motion track according to the color brightness value in the color state value set.

In a possible implementation, the motion track change unit is configured to: control the electronic device to deflect for a preset angle on the basis of the present motion track.

In a possible implementation, the motion track change unit is further configured to: control the electronic device to deflect for a fixed angle value on the basis of the present motion track.

In a possible implementation, the motion track change unit is further configured to: control the electronic device to deflect for a dynamic angle value on the basis of the present motion track.

In a possible implementation, the apparatus further includes: a motion distance determination module, configured to: determine a motion distance of the electronic device according to the detection signal.

In a possible implementation, the motion distance determination module is further configured to: acquire a change value of the detection signal; determine, according to the change value of the detection signal, a color state change value of the electronic device on the present motion track; and determine, according to a corresponding relationship between the color state change value and the motion distance, the motion distance of the electronic device based on the color state change value of the electronic device on the present motion track.

Based on the various embodiments of the disclosure above, a motion control system is further provided in the present embodiment. FIG. 8 illustrates a block diagram of a motion control system according to an embodiment of the present disclosure. As illustrated in the figure, the motion control system includes a motion control apparatus 31 according to any of the various embodiments of the disclosure and an area map 32.

The area map 32 is configured to delimit a motion area of the motion control apparatus. The area map includes motion paths of at least two different color states.

The motion area of the motion control apparatus is delimited by utilizing the area map including motion paths of at least two different color states, so that the motion control apparatus can control the motion process based on the color states. The diversity of the control process in the control system is effectively extended, and the diversity of the motion control system is improved.

As known from the various embodiments of the disclosure above, the color state may be color chroma or color brightness. Therefore, in a possible implementation, the motion paths of different color states may include: motion paths of different color chroma, motion paths of different color brightnesses, or motion paths of different color chroma and different color brightnesses.

By setting different forms of color states, the mode of controlling the motion of the electronic device can be extended to a greater extent, and the extensibility of the motion control system can be improved.

As can be seen from the above embodiments of the disclosure, the motion control apparatus moves within a motion area delimited by the area map. The size and implementation form of the area map are not limited.

In a possible implementation, the area map may be a paper map placed on the ground, and the size of the paper map is not limited and may be flexibly determined according to actual conditions. Motion paths may be drawn with at least two colors on the paper map, so that different motion paths on the map have different color chroma. The motion control apparatus may move on the paper map through the motion control method provided in various embodiments of the disclosure above. In a possible implementation, the area map may be a ground surface on which the motion path is drawn by at least two colors, and the size of the drawn ground surface is not limited and may be flexibly determined according to actual conditions, so that different motion paths on the ground have different color chroma. The motion control apparatus may move on the ground surface by the motion control method proposed in various embodiments of the disclosure above.

In a possible implementation, the area map may be a paper map placed on the ground, and the size of the paper map is not limited and may be flexibly determined according to actual conditions. Different motion paths may be formed by irradiation with at least two different illumination intensities on the paper map, so that different motion paths on the map have different color brightnesses. The motion control apparatus may move on the paper map through the motion control method provided in various embodiments of the disclosure above. In a possible implementation, the area map may be a ground surface on which different motion paths are formed by irradiation with at least two illumination intensities, and the size of the irradiated ground surface area is not limited and may be flexibly determined according to actual conditions, so that different motion paths on the ground have different color brightnesses. The motion control apparatus may move on the ground surface by the motion control method proposed in various embodiments of the disclosure above.

In a possible implementation, the area map may be a paper map placed on the ground, and the size of the paper map is not limited and may be flexibly determined according to actual conditions. Motion paths may be formed through irradiation with different color chroma of at least two different illumination intensities on the paper map, so that different motion paths on the map have different color brightnesses and different color chroma. The motion control apparatus may move on the paper map through the motion control method provided in various embodiments of the disclosure above. In a possible implementation, the area map may be a ground surface on which motion paths are formed through irradiation with different color chroma of at least two different illumination intensities, and the size of the irradiated ground surface area is not limited and may be flexibly determined according to actual conditions, so that different motion paths on the ground have different color brightnesses and different color chroma. The motion control apparatus may move on the ground surface by the motion control method proposed in various embodiments of the disclosure above.

In a possible implementation, for motion paths with different color chroma delimited on the area map, the path length, path direction, path size, and path color thereof are all not limited, so long as it is ensured that at least motion paths with different color chroma exist on the area map. In a possible implementation, the motion paths of different color chroma on the area map may be motion paths with great chroma contrast, and the specific color chroma and the number of color chroma are also not limited. In one example, three paths of red, green, and black may be drawn on the area map. In a possible implementation, the motion paths on the area map may be motion paths of with similar color chroma or gradually changing different color chroma. In a possible implementation, the area map may include at least two motion paths formed by gradually changing color chroma. The gradual change process of the gradually changing color chroma, the number of gradually changing color chroma and the form of the paths are also not limited, may be flexibly determined according to actual conditions, and are not specifically limited herein.

In a possible implementation, for motion paths with different color brightnesses delimited on the area map, the path length, path direction, path size, and brightness value thereof are not limited, so long as it is ensured that at least motion paths with different color brightnesses exist on the area map. In a possible implementation, the motion paths of different color brightnesses on the area map may be motion paths with great brightness contrast, and specific brightnesses and the number of brightnesses are also not limited. In one example, there may be motion paths of two brightnesses on the area map. In a possible implementation, the motion paths on the area map may be motion paths with similar brightnesses or gradually changing different brightness. In a possible implementation, the area map may include at least two motion paths formed by gradually changing brightness. The gradual change process of the gradually changing brightnesses, the number of gradually changing brightnesses and the form of the paths are also not limited, may be flexibly determined according to actual conditions, and are not specifically limited herein.

By setting motion paths of different color chroma formed with gradients, the motion distance of the motion control apparatus in the system can be conveniently calculated, so that the control precision is further improved.

### Example of Application Scenario

A trolley is a common form of object used in development of embedded systems. Trolleys have been used in the field of education, engineering measurement and even military and police instruments for a long time. In the related art, a patrol car with two groups of infrared sensors and with motors respectively mounted on left and right wheels has been proposed. The patrol car may carry out automatically patrolling transportation in work such as warehousing and logistics, and has high value in application.

At present, the performance of embedded system hardware and the popularity of artificial intelligence have been greatly improved. Artificial intelligence education has been popularized in junior high schools. Students have shown great interest in artificial intelligence, and educators also have great demand for computer science related majors in teaching. However, it can be seen from the above-mentioned related art that at present, most trolleys perform patrol based on paired infrared tubes. The approach is single and lacks extensibility and cannot provide sufficient support in the aspect of diversity.

Therefore, a patrol trolley which is high in patrol precision, flexible in the mode of control and easily extensible can greatly improve the students' interest in research and improve the teaching level of teachers in the teaching process. Moreover, the patrol trolley can be effectively extended and applied to other fields and plays a greater role.

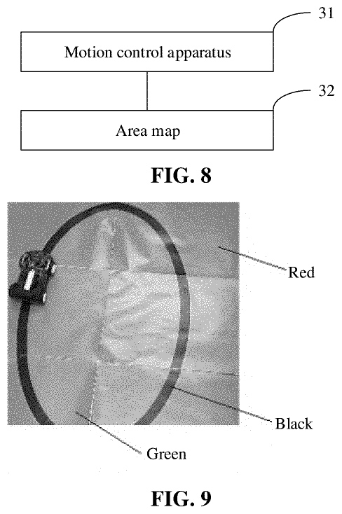

FIG. 9 illustrates a schematic diagram of an application example according to the present disclosure. As illustrated in the figure, an embodiment of the present disclosure provides a motion system mainly including two parts: a patrol trolley and an area map for delimiting a motion area of the patrol trolley.

As can be seen from the figure, in the example of the present disclosure, the area map includes three compact color paths with red, black and green colors. The patrol trolley mainly includes two parts, namely a vehicle body which may be controlled through embedded development, and a color sensor arranged on the vehicle body. The specific mounting position of the color sensor on the vehicle body is not limited, as long as the color sensor can sense the color of the area map and can transmit a sensing signal to a control system of the vehicle body. In the example of the present disclosure, the color sensor may be arranged at the lower part of the vehicle body and connected to a controller of the vehicle body.

The process of the patrol trolley moving on the area map may be as follows. The patrol trolley obtains a sensing signal by calling the color sensor to read color information of a present position on the area map and sends the sensing signal to the controller. The controller determines the color of the present motion track of the patrol trolley by analyzing the sensing signal. If the color of the present motion track is the same as the color of a path to be followed (black in the example of the present disclosure), the patrol trolley may be controlled to still advance along the present motion track. If the color of the present motion track is different from the color of the path to be followed, the patrol trolley may be controlled to adjust the motion track.

In the example of the present disclosure, the motion track may be adjusted by controlling the direction of the trolley to deflect. Specifically, in the example of the present disclosure, if the chroma of the present motion track is red, the patrol trolley may be controlled to deflect to the right by 35 degrees and then advance, and if the chroma of the present motion track is green, the patrol trolley may be controlled to deflect to the left by 35 degrees and then advance.

In the example of the present disclosure, besides the above mode of controlling the trolley to adjust the motion track, the motor and the steering engine of the patrol trolley may also be controlled in a PID mode in cooperation with differential steering of the patrol trolley for turning, so that small-angle steering of the patrol trolley is realized, and accurate patrol is thus realized.

According to the example of the present disclosure, the specific mode for the controller to determine the color of the present motion track of the patrol trolley by analyzing the sensing signal may be as follows. After RGB values are acquired through the color sensor, the controller assigns the RGB values to the R channel value, the G channel value and the B channel value respectively, then compares the RGB values with one another. If the R channel value>the G channel value and the R channel value>the B channel value, it indicates that the present detection value is red. By the same reasoning, if the G channel value>the R channel value and the G channel value>the B channel value, it indicates that the present detection value is green. If the B channel value>the R channel value and the B channel value>the G channel value, it indicates that the present detected value is black.

Through the above application example, it can be seen that in the motion control system in the present application example, the patrol trolley performs detection by using the color sensor; and the precision is controlled through the color richness in the area map, without depending on the number of sensors, and the mode of control is more diversified. Moreover, since the color sensor is used in the patrol trolley, the effect of induction can be achieved by using a single color sensor during usage; and compared with the trolley with multiple infrared sensors, the volume of the patrol trolley of the disclosure can be greatly reduced. Moreover, the color sensor may identify a path with a single color and may also be used on a map with gradually changing colors, thus having a wide range of application and being more flexible to implement, and therefore the system can be more suitable for application scenarios such as teaching. In practical application, the above motion control system may be used by teachers to carry out artificial intelligence education and teach related curriculum supporting experiments in schools, may also be used for students to participate in projects for a held artificial intelligence competition, and may also be used for the students to autonomously learn development.

It should be noted that the motion control method, apparatus and system of the embodiments of the present disclosure are not limited to be applied in the above teaching scenarios, but may also be applied in other scenarios. For example, they may be applied in sweeping a specific area by an automatic sweeping robot, or in carrying different goods by an automatic carrying robot through color recognition. This is not limited in present disclosure.

It is to be understood that the method embodiments mentioned in the present disclosure may be combined with each other to form a combined embodiment without departing from the principle and logic, which is not elaborated in the embodiments of the present disclosure for the sake of simplicity.

It may be understood by the person skilled in the art that in the method of the specific implementation, the writing sequence of various actions does not mean a strict sequence of execution to form any limit to the implementation process, and the specific sequence of executing the actions may be determined in terms of the function and possible internal logic.

In some embodiments, the functions or modules contained in the apparatus provided in the embodiment of the present disclosure may be configured to perform the methods described in the above method embodiments. The specific implementation may refer to the description of the above method embodiments, and will not be described here again for brevity.

In embodiments of the present disclosure, further provided is a computer-readable storage medium having stored thereon computer program instructions that, when is executed by a processor, implement the above method. The computer-readable storage medium may be a non-volatile computer-readable storage medium.

In embodiments of the present disclosure, further provided is an electronic device, which includes: a processor; and a memory configured to store instructions executable by the processor, the processor being configured to execute the above method.

The electronic device may be provided as a terminal, a server or other forms of devices.

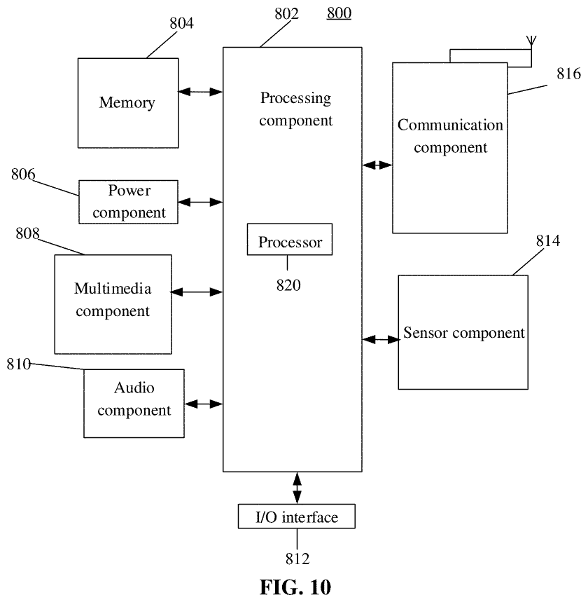

FIG. 10 illustrates a block diagram of an electronic device 800 according to an exemplary embodiment. For example, the electronic device 800 may be a terminal such as a mobile phone, a computer, a digital broadcast terminal, a messaging device, a gaming console, a tablet, a medical device, exercise equipment, and a personal digital assistant.

Referring to FIG. 10, the electronic device 800 may include one or more of the following components: a processing component 802, a memory 804, a power component 806, a multimedia component 808, an audio component 810, an Input/Output (I/O) of interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the actions in the above described methods. Moreover, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store various types of data to support the operation of the electronic device 800. Examples of such data include instructions for any program or method operated on the electronic device 800, contacts data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 806 provides power to various components of the electronic device 800. The power component 806 may include a power management system, one or more power sources, and any other components associated with the generation, management and distribution of power in the electronic device 800.

The multimedia component 808 includes a screen providing an output interface between the electronic device 800 and the user. In some embodiments, the screen may include a Liquid Crystal Display (LCD) and a Touch Panel (TP). If the screen includes a TP, the screen may be implemented as a touch screen to receive input signals from the user. The TP includes one or more touch sensors to sense touches, swipes and gestures on the TP. The touch sensors may not only sense a boundary of a touch or swipe action, but also sense a duration and a pressure associated with the touch or swipe action. In some embodiments, the multimedia component 808 includes a front camera and/or a rear camera. The front camera and/or the rear camera may receive external multimedia data while the electronic device 800 is in an operation mode, such as a photographing mode or a video mode. Each of the front camera and the rear camera may be a fixed optical lens system or have focus and optical zooming capability.

The audio component 810 is configured to output and/or input audio signals. For example, the audio component 810 includes a Microphone (MIC) configured to receive an external audio signal when the electronic device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, or a button. The button may include, but is not limited to, a home button, a volume button, a starting button, and a lock button.

The sensor component 814 includes one or more sensors to provide status assessments of various aspects of the electronic device 800. For example, the sensor component 814 may detect an open/closed status of the electronic device 800, and relative positioning between components. For example, the component is the display and the keypad of the electronic device 800. The sensor component 814 may also detect a change in position of the electronic device 800 or a component of the electronic device 800, a presence or absence of user contact with the electronic device 800, an orientation or an acceleration/deceleration of the electronic device 800, and a change in temperature of the electronic device 800. The sensor component 814 may include a proximity sensor configured to detect the presence of nearby objects without any physical contact. The sensor component 814 may also include a light sensor, such as a Complementary Metal Oxide Semiconductor (CMOS) or Charge Coupled Device (CCD) image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the electronic device 800 and other devices. The electronic device 800 may access a wireless network based on a communication standard, such as Wireless Fidelity (WiFi), a 2^{nd}-generation (2G) network or a 3^{rd}-generation (3G) network, or a combination thereof. In one exemplary embodiment, the communication component 816 receives a broadcast signal or broadcast-associated information from an external broadcast management system via a broadcast channel In one exemplary embodiment, the communication component 816 further includes a Near Field Communication (NFC) module to facilitate short-range communications. For example, the NFC module may be implemented based on a Radio Frequency Identification (RFID) technology, an Infrared Data Association (IrDA) technology, an Ultra-Wideband (UWB) technology, a Bluetooth (BT) technology, and other technologies.

In exemplary embodiments, the electronic device 800 may be implemented with one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors, or other electronic elements, for performing the above described methods.

In an exemplary embodiment, a non-volatile computer-readable storage medium, for example, a memory 804 including computer program instructions, is also provided. The computer program instructions may be executed by a processor 820 of an electronic device 800 to implement the above-mentioned method.

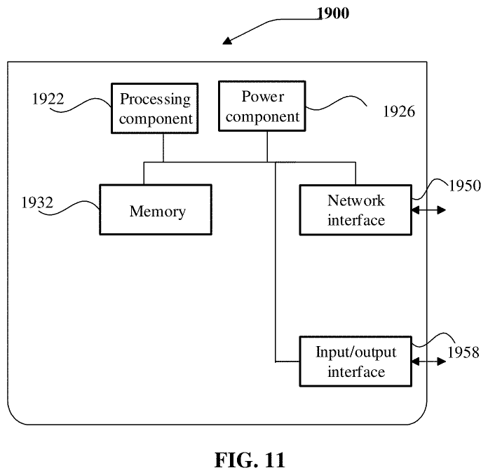

FIG. 11 illustrates a block diagram of an electronic device 1900 according to an exemplary embodiment. For example, the electronic device 1900 may be provided as a server. As illustrated in FIG. 11, the electronic device 1900 includes: a processing component 1922 further including one or more processors; and a memory resource represented by a memory 1932, configured to store instructions executable for the processing component 1922, for example, an application. The application stored in the memory 1932 may include one or more modules, with each module corresponding to one group of instructions. In addition, the processing component 1922 is configured to execute the instructions to perform the above-mentioned method.

The electronic device 1900 may further include a power component 1926 configured to execute power management of the electronic device 1900, a wired or wireless network interface 1950 configured to connect the electronic device 1900 to a network and an I/O interface 1958. The electronic device 1900 may be operated based on an operating system stored in the memory 1932, for example, Windows Server™, Mac OS X™, Unix™, Linux™, FreeBSD™ or other operating systems.

In an exemplary embodiment, a non-volatile computer-readable storage medium, for example, a memory 1932 including computer program instructions, is also provided. The computer program instructions may be executed by a processing component 1922 of an electronic device 1900 to implement the above-mentioned method.

An embodiment of the present disclosure also provides a computer program. The computer program, when executed by a processor, implements any motion control method described above.

The present disclosure may lie in a system, a method and/or a computer program product. The computer program product may include a computer-readable storage medium, in which computer-readable program instructions configured to enable a processor to implement each aspect of the present disclosure is stored.

The computer-readable storage medium may be a tangible device capable of retaining and storing instructions used by an instruction execution device. The computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with instructions stored therein, and any appropriate combination thereof. Herein, the computer-readable storage medium is not explained as a transient signal, for example, radio waves or other freely propagating electromagnetic waves, electromagnetic waves propagating through a waveguide or another transmission medium (for example, an optical pulse propagating through an optical fiber cable) or an electric signal transmitting through an electric wire.

The computer-readable program instructions described here may be downloaded from the computer-readable storage medium to each computing/processing device or downloaded to an external computer or an external storage device through a network such as an Internet, a Local Area Network (LAN), a Wide Area Network (WAN) and/or a wireless network. The network may include a copper transmission cable, an optical fiber transmission cable, a wireless transmission cable, a router, a firewall, a switch, a gateway computer and/or an edge server. A network adapter card or network interface in each computing/processing device receives the computer-readable program instructions from the network and forwards the computer-readable program instructions for storage in the computer-readable storage medium in each computing/processing device.

The computer program instructions configured to execute the operations of the present disclosure may be assembly instructions, an Instruction Set Architecture (ISA) instructions, machine instructions, machine related instructions, microcode, firmware instructions, state setting data or source code or target code edited by any combination of one or more programming languages, the programming language including an object-oriented programming language such as Smalltalk and C++ and a conventional procedural programming language such as “C” language or a similar programming language. The computer-readable program instructions may be completely or partially executed in a computer of a user, executed as an independent software package, executed partially in the computer of the user and partially in a remote computer, or executed completely in the remote server or a server. In a case involving the remote computer, the remote computer may be connected to the user computer via a type of network including the LAN or the WAN, or may be connected to an external computer (such as using an Internet service provider to provide the Internet connection). In some embodiments, an electronic circuit, such as a programmable logic circuit, a Field Programmable Gate Array (FPGA) or a Programmable Logic Array (PLA), is customized by using state information of the computer-readable program instructions. The electronic circuit may execute the computer-readable program instructions to implement each aspect of the present disclosure.

Herein, each aspect of the present disclosure is described with reference to flowcharts and/or block diagrams of the method, device (system) and computer program product according to the embodiments of the present disclosure. It is to be understood that each block in the flowcharts and/or the block diagrams and a combination of each block in the flowcharts and/or the block diagrams may be implemented by computer-readable program instructions.

These computer-readable program instructions may be provided for a processor of a universal computer, a dedicated computer or another programmable data processing device, thereby generating a machine to further generate a device that realizes a function/action specified in one or more blocks in the flowcharts and/or the block diagrams when the instructions are executed through the processor of the computer or the other programmable data processing devices. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may also be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate architectures, functions and operations that may be implemented by the system, method and computer program product according to multiple embodiments of the present disclosure. On this aspect, each block in the flowcharts or the block diagrams may represent part of a module, a program segment or instructions, and part of the module, the program segment or the instructions includes one or more executable instructions configured to realize a specified logical function. In some alternative implementations, the functions marked in the blocks may also be realized in a sequence different from those marked in the drawings. For example, two continuous blocks may actually be executed in a substantially concurrent manner and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Various embodiments of the present disclosure have been described above. The above descriptions are exemplary, non-exhaustive and also not limited to various embodiments of the disclosure above. Many modifications and variations would be apparent to those of ordinary skill in the art without departing from the scope and spirit of each described embodiment of the present disclosure. The terms used herein are selected to explain the principle and practical application of each embodiment or technical improvements in the technologies in the market best or enable others of ordinary skill in the art to understand the embodiments disclosed herein.

1. A motion control method, comprising:
acquiring a detection signal, wherein the detection signal is generated by an electronic device through sensing a color state of a present motion track of the electronic device; and
controlling motion of the electronic device according to the detection signal.

2. The motion control method according to claim 1, wherein the color state comprises at least one of:
a color chroma state, or
a color brightness state.

3. The motion control method according to claim 1, wherein controlling the motion of the electronic device according to the detection signal comprises:
acquiring a color state value set in the detection signal; and
controlling the motion of the electronic device according to all color state values in the color state value set.

4. The motion control method according to claim 3, wherein controlling the motion of the electronic device according to all the color state values in the color state value set comprises:
determining the color state of the present motion track according to all the color state values in the color state value set; and
controlling the motion of the electronic device by one of the following:
in response to that the color state of the present motion track is consistent with a preset color state, controlling the electronic device to continue to move along the present motion track; or
in response to that the color state of the present motion track is inconsistent with the preset color state, controlling the electronic device to change the present motion track and move along the changed motion track.

5. The motion control method according to claim 4, wherein determining the color state of the present motion track according to all the color state values in the color state value set comprises:
reading all color chroma values in the color state value set; and determining a color chroma of the present motion track according to a relationship of magnitude between all the color chroma values; or
reading a color brightness value in the color state value set; and determining a color brightness of the present motion track according to the color brightness value in the color state value set.

6. The motion control method according to claim 5, wherein determining the color chroma of the present motion track according to the relationship of magnitude between all the color chroma values comprises:
determining that the color chroma of the present motion track is red in response to that a red (R) channel value is larger than both a green (G) channel value and a black (B) channel value among all the color chroma values;
determining that the color chroma of the present motion track is green in response to that the G channel value is larger than both the R channel value and the B channel value among all the color chroma values; or
determining that the color chroma of the present motion track is black in response to that the B channel value is larger than both the R channel value and the G channel value among all the color chroma values.

7. The motion control method according to claim 4, wherein controlling the electronic device to change the present motion track comprises:
controlling the electronic device to deflect for a preset angle on the basis of the present motion track.

8. The motion control method according to claim 7, wherein controlling the electronic device to deflect for the preset angle on the basis of the present motion track comprises:
controlling the electronic device to deflect for a fixed angle value on the basis of the present motion track; or
controlling the electronic device to deflect for a dynamic angle value on the basis of the present motion track.

9. The motion control method according to claim 1, further comprising:
determining a motion distance of the electronic device according to the detection signal.

10. The motion control method according to claim 9, wherein determining the motion distance of the electronic device according to the detection signal comprises:
acquiring a change value of the detection signal;
determining, according to the change value of the detection signal, a color state change value of the electronic device on the present motion track; and
determining, according to a corresponding relationship between the color state change value and the motion distance, the motion distance of the electronic device based on the color state change value of the electronic device on the present motion track.

11. A motion control apparatus, comprising:
a processor; and
a memory configured to store instructions executable by the processor,
wherein the processor is configured to call the instructions stored in the memory to perform a motion control method, the motion control method comprising:
acquiring a detection signal, wherein the detection signal is generated by an electronic device through sensing a color state of a present motion track of the electronic device; and
controlling motion of the electronic device according to the detection signal.

12. The motion control apparatus according to claim 11, wherein the color state comprises at least one of:
a color chroma state, or
a color brightness state.

13. The motion control apparatus according to claim 11, wherein controlling the motion of the electronic device according to the detection signal comprises:
acquiring a color state value set in the detection signal; and
controlling the motion of the electronic device according to all color state values in the color state value set.

14. The motion control apparatus according to claim 13, wherein controlling the motion of the electronic device according to all the color state values in the color state value set comprises:
determining the color state of the present motion track according to all the color state values in the color state value set; and
controlling the motion of the electronic device by one of the following:
in response to that the color state of the present motion track is consistent with a preset color state, controlling the electronic device to continue to move along the present motion track; or
in response to that the color state of the present motion track is inconsistent with the preset color state, controlling the electronic device to change the present motion track and move along the changed motion track.

15. The motion control apparatus according to claim 14, wherein determining the color state of the present motion track according to all the color state values in the color state value set comprises:
reading all color chroma values in the color state value set; and determining a color chroma of the present motion track according to a relationship of magnitude between all the color chroma values; or
reading a color brightness value in the color state value set; and determining a color brightness of the present motion track according to the color brightness value in the color state value set.

16. The motion control apparatus according to claim 15, wherein determining the color chroma of the present motion track according to the relationship of magnitude between all the color chroma values comprises:
determining that the color chroma of the present motion track is red in response to that a red (R) channel value is larger than both a green (G) channel value and a black (B) channel value among all the color chroma values;
determining that the color chroma of the present motion track is green in response to that the G channel value is larger than both the R channel value and the B channel value among all the color chroma values; or
determining that the color chroma of the present motion track is black in response to that the B channel value is larger than both the R channel value and the G channel value among all the color chroma values.

17. The motion control apparatus according to claim 11, wherein the motion control method further comprises:
determining a motion distance of the electronic device according to the detection signal.

18. The motion control apparatus according to claim 17, wherein determining the motion distance of the electronic device according to the detection signal comprises:
acquiring a change value of the detection signal;
determining, according to the change value of the detection signal, a color state change value of the electronic device on the present motion track; and
determining, according to a corresponding relationship between the color state change value and the motion distance, the motion distance of the electronic device based on the color state change value of the electronic device on the present motion track.

19. A motion control system, comprising:
the electronic device according to claim 11; and
an area map, configured to delimit a motion area of the electronic device, wherein the area map comprises motion paths of at least two different color states.

20. A non-transitory computer-readable storage medium having stored thereon computer program instructions that, when executed by a processor, implement a motion control method comprising:
acquiring a detection signal, wherein the detection signal is generated by an electronic device through sensing a color state of a present motion track of the electronic device; and
controlling motion of the electronic device according to the detection signal.
